(19) United States
(12) Patent Application Publication
(10) Pub. No.: US 2024/0401929 A1
(43) Pub. Date: Dec. 5, 2024

(54) AIRBORNE INSPECTION METROLOGY

(71) Applicant: Caterpillar Inc., Peoria, IL (US)

(72) Inventor: Matthew Jacob BEHMLANDER, West Olive, MI (US)

(73) Assignee: Caterpillar Inc., Peoria, IL (US)

(21) Appl. No.: 18/203,684

(22) Filed: May 31, 2023

(51) Int. Cl. G01B 11/00; B64U 10/14; G05D 1/10; G08G 5/00

(52) U.S. Cl. CPC G01B 11/005; B64U 10/14; G08G 5/0034; G08G 5/0069; B64U 2101/26

(57) ABSTRACT

An airborne coordinate measuring machine (CMM) includes a noncontact 3D scanner constructed to obtain measurement data of an object under scrutiny and a drone aircraft mechanically coupled to the 3D scanner and constructed to traverse a flight path that is specific to the object under scrutiny.

### TECHNICAL FIELD

The present disclosure generally relates to airborne coordinate measurement machines (CMMs). More specifically, this disclosure is directed to component inspection by drone metrology.

### BACKGROUND

Coordinate measurement machines (CMMs) are devices by which geometric features of physical objects are captured and provided as point data, curve data, triangle mesh data, among others. CMMs are used in a wide array of technical fields for component measurement and inspection, 3D component surface modeling, reverse engineering, among other things. CMMs are realized in a variety of physical configurations including those with mechanical probes that contact the component being measured and those based on noncontact optical scanning.

Challenges to CMM are encountered where the object being inspected is large and/or where surfaces being measured are difficult to reach. Advancements in handheld optical scanner technology have afforded highly mobile measurements of large objects, while lightweight autonomous aerial vehicles have become easier to control and are more stable than ever before. Several solutions exist that combine these technologies for the purpose of measuring hard to reach objects. US Patent Application Publication 2013/0215433, for example, is directed to a hover CMM, as it is referred to in the document, using a noncontact CMM probe that measures objects and that is installed on a drone aircraft. An optical localizer is used for tracking the position of the probe and thus a continuous line of sight with the probe is required. The reference discusses the use of multiple localizers deployed around the object being measured to maintain that line of sight. As another example, U.S. Pat. No. 9,482,524 is directed to a measuring system for determining 3D coordinates of an object's surface that is similar to the hover CMM system discussed above. The measuring system in this patent reference includes a probe, e.g., an optical scanner, that is airborne, i.e., attached to a drone, and is tracked via one or more trackers disposed about the object being measured. The trackers are distributed to maintain line of sight with the airborne optical scanner over the duration of the measurement flight.

U.S. Pat. No. 10,234,278, on the other hand, describes an aerial device having a three-dimensional measurement device. In this example, a surface being measured is scanned from different angles, either by an additional tracker or additional aerial device, using a known scan pattern. Triangulation from the different views is used to transpose coordinates.

These example systems all generate 3D data from which measurements are obtained and all require varying degrees of site preparation for measurement, particularly where the object being inspected is large. Ongoing research, engineering and product development efforts are devoted to improving measurement efficiency in airborne coordinate measuring systems.

### SUMMARY

In one aspect of the present inventive concept, an airborne coordinate measuring machine (CMM) comprises a noncontact 3D scanner constructed to obtain measurement data of an object under scrutiny and a drone aircraft mechanically coupled to the 3D scanner constructed to traverse a flight path that is specific to the object under scrutiny.

In another aspect, an airborne inspection metrology system is constructed to inspect an object and includes an airborne coordinate measuring machine (CMM) comprising a noncontact 3D scanner constructed to obtain measurement data of an object under scrutiny and a drone aircraft mechanically coupled to the 3D scanner and constructed to traverse a flight path that is specific to the object under scrutiny. An information system is communicatively coupled to the 3D scanner to accept the measurement data therefrom and to the drone aircraft to convey flight path data thereto that defines the flight path.

In yet another aspect of the present inventive concept, a method of component inspection by airborne inspection metrology includes irradiating a surface region on the component with an airborne laser. Laser returns reflected from the irradiated surface region on the component are accepted at an airborne detector and measurement data are generated from the laser returns that are assigned coordinates of a local reference frame. The coordinates of the local reference frame are translated into coordinates of a global reference frame from which physical distance can be determined. The measurement data translated into the global reference frame are analyzed to determine whether they meet specifications defined on a component model of the component.

### BRIEF DESCRIPTION OF THE DRAWINGS

FIG. 1 is an illustration of an exemplary CMM system by which the present inventive concept can be embodied.

FIG. 2 is a schematic block diagram of an exemplary CMM system by which the present inventive concept can be embodied.

FIG. 3 is a schematic illustration of an exemplary component inspection process by which the present inventive concept can be embodied.

FIGS. 4A and 4B is a flow diagram over two (2) drawing pages of an exemplary airborne CMM process by which the present inventive concept can be embodied.

### DESCRIPTION OF EXAMPLE EMBODIMENTS

The present inventive concept is best described through certain embodiments thereof, which are described in detail herein with reference to the accompanying drawings, wherein like reference numerals refer to like features throughout. It is to be understood that the term inventive concept and the term invention, when used herein, are intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

Furthermore, mathematical expressions are contained herein, including the disclosures incorporated herein by reference, and those principles conveyed thereby are to be taken as being thoroughly described therewith. It is to be understood that where mathematics are used, such is for succinct description of the underlying principles being explained and, unless otherwise expressed, no other purpose is implied or should be inferred. It will be clear from this disclosure overall how the mathematics herein pertain to the present invention and, where embodiment of the principles underlying the mathematical expressions is intended, the ordinarily skilled artisan will recognize numerous techniques to carry out physical manifestations of the principles being mathematically expressed.

The figures described herein include schematic block diagrams illustrating various interoperating functional modules. Such diagrams are not intended to serve as electrical schematics and interconnections illustrated are intended to depict signal flow, various interoperations between functional components and/or processes and are not necessarily direct electrical connections between such components. Moreover, the functionality illustrated and described via separate components need not be distributed as shown, and the discrete blocks in the diagrams are not necessarily intended to depict discrete electrical components.

The techniques described herein are directed to component inspection by airborne metrology. Upon review of this disclosure and appreciation of the concepts disclosed herein, the ordinarily skilled artisan will recognize other metrological contexts in which the present inventive concept can be applied. The scope of the present invention is intended to encompass all such alternative implementations.

Exemplary CMM techniques described herein include those that computationally transform coordinates of a local reference frame into coordinates of a global reference frame. As used herein, the term “local reference frame” is intended to refer to a coordinate system in which data points are associated by a relative distance from a local origin. The term “global reference frame” is intended to refer to a coordinate system in which data points are associated by a relative distance from a global origin that may be separate and distinct from the local origin. As one example, a “point cloud,” as the term is used herein consistently with its generally held definition, is a metaphor in which individual data points are seen as occupying space in a cloud formation. Assuming Cartesian coordinates, the data point at coordinates (x_{L}, y_{L}, z_{L}) may be referred to as data point (x_{L}, y_{L}, z_{L}) in a point cloud having a local origin (0_{L}, 0_{L}, 0_{L}) from which all points in a local reference frame are referenced. For purposes of computation and data processing, values for coordinates (x_{L}, y_{L}, z_{L}) may be assigned to data fields of a data structure that encompasses all data points (x_{L}, y_{L}, z_{L}) in the local reference frame of the point cloud. Following the metaphor of the point cloud occupying space, the distance from local origin (0_{L}, 0_{L}, 0_{L}) to any data point (x_{L}, y_{L}, z_{L}) in the cloud may not be in units of measurable distance, but of “dimensionless” distance, meaning a unitless distance metric that is independent of physical space. By contrast, space in the global reference frame may be measured against a physical standard and distance between coordinates (x_{G}, y_{G}, z_{G}) may be quantifiable in, for example, a standardized system of measurement (US Customary Units, International System of Units, etc.). Accordingly, coordinates (x_{G}, y_{G}, z_{G}) may be measurable from a fixed anchor point (0_{G}, 0_{G}, 0_{G}) of the global reference frame in physical units of measure. The translation of the local reference frame into the global reference frame may include computational translation of points (x_{L}, y_{L}, z_{L}) in the local reference frame of the point cloud into corresponding points (x_{G}, y_{G}, z_{G}) of the global reference frame in a manner in which the dimensionless distances from data point (x_{L}, y_{L}, z_{L}) to local origin (0_{L}, 0_{L}, 0_{L}) are relatively maintained in the physically measurable distances from point (x_{G}, y_{G}, z_{G}) to global origin (0_{G}, 0_{G}, 0_{G}). When this translation has occurred, a surface may be rendered or otherwise integrated over the translated point cloud data sufficiently for comparison of the surface against its design specifications.

The term “anchor position” is intended to refer to the location at an inspection site that serves as an inspection zero point, or equivalently, global origin (0_{G}, 0_{G}, 0_{G}). The anchor position may be specified in global coordinates, e.g., latitude/longitude and/or a known distance to the component being inspected.

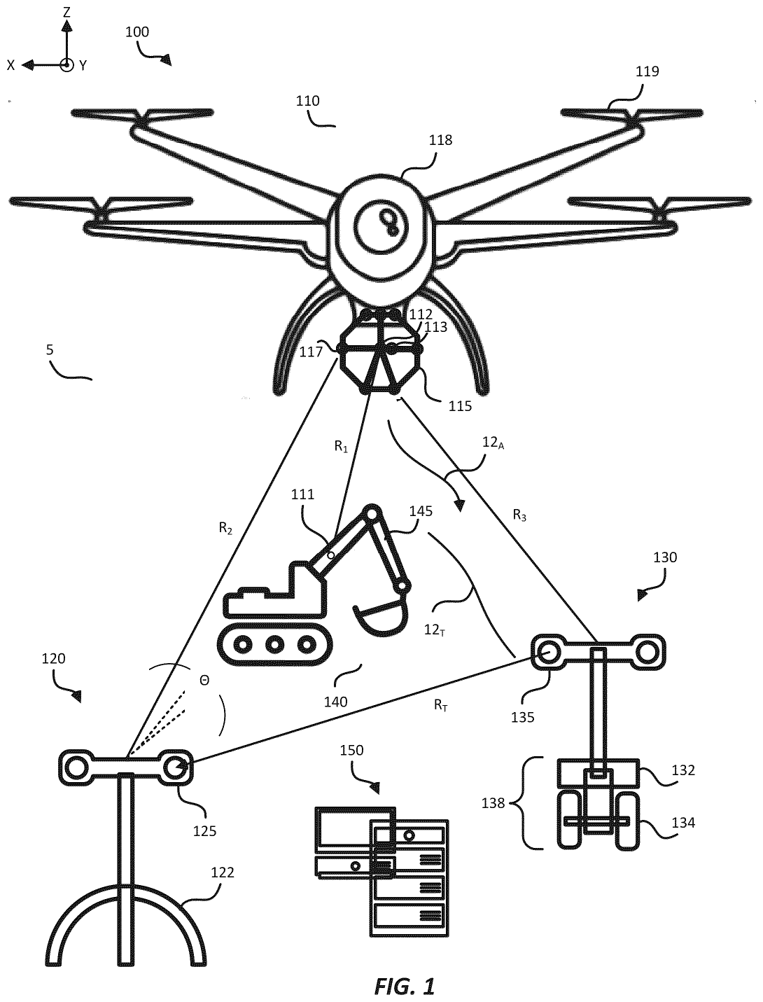

FIG. 1 is an illustration of an exemplary CMM system 100 by which the present inventive concept can be embodied. Exemplary CMM system 100 may obtain geometric information on objects, such as an excavator 140 stationed at inspection site 5, by noncontact probing over some or all of its surface 145. It is to be understood that the present inventive concept is not limited to specific contact and noncontact CMM probing techniques; nevertheless, the examples presented herein are primarily confined to 3D optical scanning, as the term is generally understood in CMM art, in which data points represent depth, i.e., normal to the plane being measured, as well as that represent a position in two dimensions parallel to that plane. Skilled artisans can extend the principles described herein to other CMM probing techniques and remain within the spirit and intended scope of the inventive concept.

In the embodiment illustrated, CMM system 100 generally includes an airborne optical scanner, referred to herein simply as airborne scanner 110, a mobile optical tracker, referred to herein simply as mobile tracker 130, a base optical tracker, referred to herein simply as base tracker 120, and a central or common information infrastructure, referred to herein as CMM information system 150. Airborne scanner 110, mobile tracker 130 and base tracker 120 may be deployed at inspection site 5 while CMM information system 150 may reside at a location remote from inspection site 5. Broadly, airborne scanner 110 may irradiate a scanning region 111 on surface 145 of excavator 140 from a laser array 112, representatively illustrated in FIG. 1 by its effective aperture, and may collect laser returns at a detector array 113, representatively illustrated in FIG. 1 by its effective aperture. The range R₁ may be determined from these laser returns and represented as a point (x_{L}, y_{L}, z_{L}) of a point cloud defining a local reference frame to airborne scanner 110. Information derived from the laser returns, luminance, for example, may be assigned to point (x_{L}, y_{L}, z_{L}), but such value assignments are not necessary to practice the present inventive concept As scanning region 111 is moved over surface 145, such as by airborne scanner 110 following a flight path 12_{A}, such points (x_{L}, y_{L}, z_{L}) may be collected into a point cloud data structure in memory, for example and be subsequently assigned physical dimensions by translation into a global reference frame, such as that discussed above. The known point in space serving as global origin (0_{G}, 0_{G}, 0_{G}) may be provided by the position of a base tracker 120 with line-of-sight (LOS) to airborne scanner 110 being provided by a mobile tracker 130, as described in more detail below. With surface 145 defined in physical dimensions, it may be compared with specifications for that surface 145 of excavator 140. In certain implementations, the surface representation may be rendered as the corresponding surface of a computer model of excavator 140 with discrepancies indicating variations from the specification of excavator 140 as defined in the computer model.

As illustrated in FIG. 1, airborne scanner 110 may comprise a stable airborne platform 118, referred to herein as drone 118, and a 3D optical scanner, referred to herein simply as optical scanner 115, mechanically attached thereto. The present inventive concept is not limited to specific aircraft configurations provided the implemented configuration is sufficiently stable in flight to limit its impact on component measurement to a tolerable yet known quantity. To that end, exemplary drone 118 may employ propellors, representatively illustrated at propellor 119, whose rotational speed and direction may be controlled to achieve a stable flight throughout flight path 12A. As will be discussed further below, embodiments of the present inventive concept may maintain a collection of flight path definitions, such as in a database at CMM information system 150, that are specific to respective objects that are to be inspected. Flight path 12A, then, may be specific to excavator 140 to measure surfaces 145 relevant to the inspection at hand-over the duration of the flight.

Exemplary base tracker 120 may include a base 122, such as a tripod, which may be deployed at a fixed position at inspection site 5. The fixed position may serve as an origin (0_{G}, 0_{G}, 0_{G}) of a global reference frame and an optical scanning head 125 may be supported on base 122. Base tracker 120 may obtain range and other information regarding airborne CMM 110 to the extent that LOS with airborne scanner 110 is maintained over flight path 12A. The fixed spatial position of base tracker 120 may be programmed or stored in a reference processor 244 consulted during CMM measurements and used in triangulation computations, for example, by which point clouds generated by embodiments of the present inventive concept can be translated into the global reference frame and thereby obtain physical dimensions for comparison with specifications for the object being inspected, e.g., excavator 140.

In addition to generating point cloud data as described above, optical scanner 115 may include a set of markers, representatively illustrated at marker 117, distributed over its structure. Markers 117 may be followed by base tracker 120 to determine not only range R₂ but the orientation of optical scanner 115 as well. In certain instances, LOS between airborne scanner 110 and base tracker 120 may be lost over a solid angle θ that corresponds to excavator 140 being physically interposed therebetween. To maintain tracking of airborne scanner 110 in such instances, embodiments of the present inventive concept may include mobile tracker 130 comprising an optical scanning head 135 on a mobile base 138. Mobile base 138 may include a mobile drive 132 that operates one or more locomotors 134, such as wheels, tracks, etc., by which a tracker path 12_{T} may be traversed. Tracker path 12_{T} may be defined to maintain LOS communication with airborne scanner 110 over the spatial region corresponding to solid angle θ. Tracker path 12_{T} may be further defined to maintain LOS communication with base tracker 120 while airborne scanner 110 collects data over the spatial region corresponding to solid angle θ. While mobile tracker 130 and base tracker 120 are in optical contact, mobile tracker 130 may determine a range R_{T} to base tracker 120 from which it may compute its location in coordinates of the global reference frame. The point cloud data in the local reference frame collected by airborne scanner 110 may be translated into the global reference frame with knowledge of range R₃, R_{T} and spatial triangulation computation techniques. It is to be noted that both R₃ and R_{T} change as mobile tracker 130 traverses tracker path 12_{T} to maintain LOS communications with both airborne CMM 110 and base tracker 120. The local reference frame of airborne CMM 110 thus remains correlated to the global reference frame defined by the position of base tracker 120.

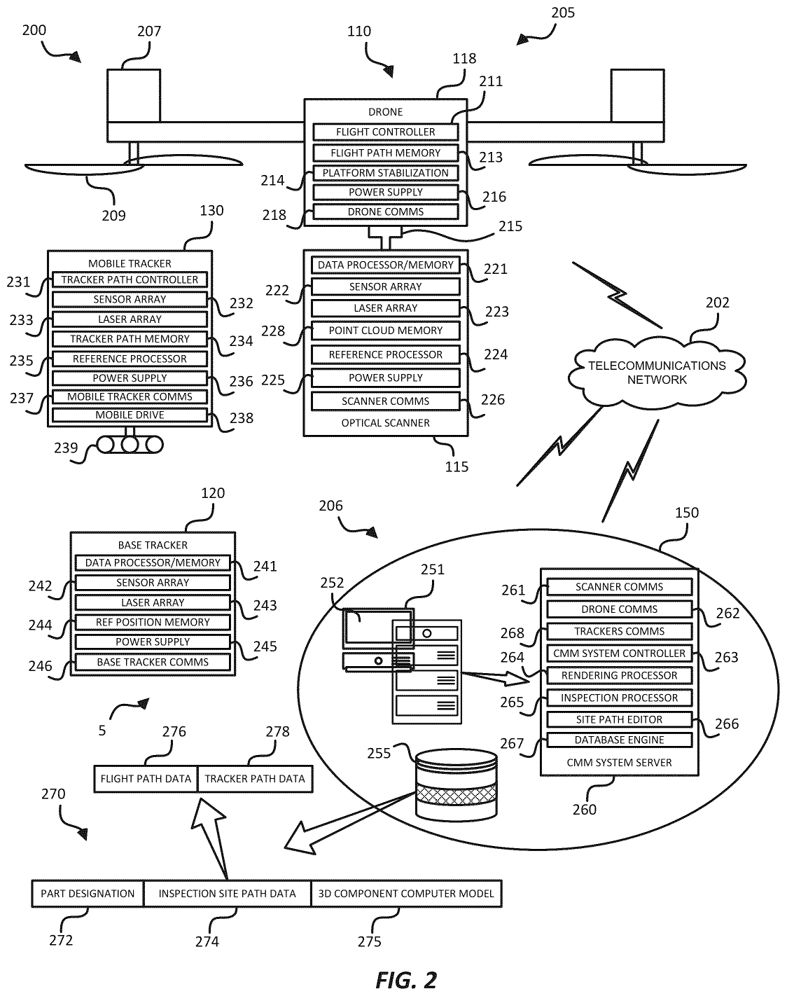

FIG. 2 is a schematic block diagram of an exemplary CMM system 200 by which the present inventive concept can be embodied. CMM system 200 may comprise like equipment as CMM system 100, e.g., an airborne scanner 110, a base tracker 120, a mobile tracker 130 and a CMM information system 150. For purposes of explanation but not limitation, CMM system 200 may be considered as comprising onsite resources 205 deployed at the inspection site, e.g., inspection site 5 illustrated in FIG. 1, that include airborne scanner 110, base tracker 120, mobile tracker 130, and remote resources 206 that includes CMM information system 150.

CMM information system 150 may include one or more workstations, representatively illustrated at workstation 251, and one or more servers, representatively illustrated at CMM system server 260. Workstation 251 may be constructed or otherwise configured with access to computational resources (data processor circuitry, memory circuitry, etc.) of CMM system server 260 through appropriate commands and/or requests for information. For example, workstation 251 may implement a user interface, representatively illustrated at user interface 252, by which the user can issue such commands and requests, but also can establish parameters of airborne metrology operations, review results thereof, prepare corresponding inspection reports, and so on.

General control over airborne CMM system 200 may be provided by a CMM system controller 263 executing on CMM system server 260. Such general control may include coordinating functionality between system components of CMM system 200, conveying information to and from the system components via respective communication adaptors/processors, formatting data for different phases of the inspection process, and so on. Various conventional or otherwise well-known system control techniques may be brought to bear to implement CMM system controller 263 without departing from the spirit and intended scope of the present inventive concept.

CMM system server 260 may implement a site path editor 266 by which component-specific inspection paths for airborne CMM 110, by way of flight path data 276, and mobile tracker 130, by way of tracker path data 278, can be created, edited, and stored. Site path editor 266 may employ automated computer executed path finding processes based on the topology of each object to be inspected and the optical configuration of optical scanner 115, e.g., the effective apertures of sensor array 222 and laser array 223, the recommended standoff distance between optical scanner 115 and the object being inspected, and so on. As an example, a general flight path may proceed over a prescribed distance from the object being inspected, e.g., 2-4 feet from the object, and may cover the surface of the object in swaths that overlap previous swaths by, for example, ¾ of the width of the scanning region, e.g., scanning region 111 depicted in FIG. 1. Site path editor 266 may compute a component-specific flight path that maintains such general flight parameters over the relevant inspection surfaces on the specific object being inspected. In addition to general flight parameters, site path editor 266 may define relative scanning angles of optical scanner 115 and the component-specific surface(s) being scanned. That is, optical scanner 115 may be mechanically coupled to drone 118 through an optical scanner mount 215 and, when so embodied, a scanner orientation enumerated by, for example, roll, pitch, yaw angles, may be specified for different locations on inspection flight path 12_{A}. Additionally, site path editor 266 may compute a flight-path-specific tracker path that maintains LOS with both airborne CMM 110 and base tracker 120 as airborne CMM 110 traverses its component-specific flight path. Site path editor 266 may further implement manual editing processes through which flight and tracker paths generated by automated techniques can be modified, such as to ensure sufficient scanning coverage of the entire surface, or through which a flight or tracker path can be created outright. Such manual editing features may be achieved through suitable controls realized and displayed on user interface 252. The completed flight path may be processed into computer-readable flight path data 276 understood by drone 118 or, more specifically, by flight controller 211 onboard drone 118. Similarly, the completed tracker path may be processed into computer-readable tracker path data 278 understood by tracker path controller 231 onboard mobile tracker 130. Exemplary inspection site path data 274, which may include flight path data 276 and tracker path data 278, may be stored as a database entry 270 in database 255. Database entry 270 may be realized in a database table row, for example, that associates the computer readable inspection site path data 274 with a part designation 272, e.g., a part number of the object to be inspected, and a 3D component computer model 275. When so implemented, a database query made through, for example, database engine 267 accessed through user interface 252 for a particular part or component may return database entry 270 from which inspection site path data 274 can be extracted. The extracted inspection flight path data 276 may be uploaded to flight path memory 213 onboard drone 118 where it may be executed by flight controller 211 and the extracted tracker path data 278 may be uploaded to tracker path memory 234 onboard mobile tracker 130 where it may be executed by tracker path controller 231.

As illustrated in FIG. 2, onsite resources 205 may be locally powered at the subsystem level. That is, each subsystem included in onsite resources 205 may comprise its own local power supply: a power supply 216 in drone 118, a power supply 225 in optical scanner 115, a power supply 236 in mobile tracker 130, and a power supply 245 in base tracker 120. The power supplies of onsite resources 205 may be batteries, fuel cells and the like, but not to exclude fuel burning power sources like internal combustion engines. Power supplies 216, 225, 236 and 245 may each implement separate and distinct electricity generating techniques. For example, power supply 216 of drone 118 may include inverter circuits suitable for driving drone motors, representatively illustrated at drone motor 207, while other subsystems, base tracker 120 for example, may not require alternating current and may operate from direct current derived from a battery, for example.

In the illustrated example of FIG. 2, base tracker 120 may include exemplary data processor/memory circuitry 241 that represents circuitry that is sufficient to execute computer processes and store data to realize base tracker functionality described herein. The computational resources of data processor/memory 241 on base tracker 130 may include general and specific-purpose processing and memory circuitry that may vary in architecture across implementations of CMM system 200. As discussed above, base tracker 120 may be deployed on inspection site 5 at a fixed anchor position that may be programmed or otherwise stored in reference position memory 244 and referenced throughout the CMM inspection or other data ingest application.

Subsystems of exemplary CMM system 200 may interact locally among onsite resources 205, e.g., airborne scanner 110 or equivalently, the physical combination of drone 118 and optical scanner 115, mobile tracker 130 and base tracker 120, and remotely with CMM information system 150 through signaling and messaging interfaces sufficient to achieve the distributed, coordinated functionality described herein. Whereas these signaling and messaging interfaces may be constructed or otherwise configured for communication over wired communication links, the illustrated embodiment will be described in terms of wireless communications among subsystems of CMM system 200. Skilled artisans will appreciate however that wired communication links may be included in an end-to-end connection that is primarily wireless and described herein as being so.

As illustrated in FIG. 2, the subsystems of CMM system 200 may intercommunicate over a telecommunications network 202, which may include subnetworks between groups of components that are distinct from other subnetworks in telecommunications network 202. For example, communication between onsite resources 205 may be achieved through local point-to-point communication techniques of ad-hoc and/or infrastructure optical or radio networks, and/or through wide area techniques such as cellular communications and the Internet of Things. Communication between onsite resources 205 and CMM information system 150 may be achieved through both wireless and wired technologies and protocols, such as those under which the Internet operates. Telecommunications network 202 is intended to represent many possible general systems for information exchange between endpoint terminals of onsite resources 205 and remote resources 206 as would be recognized by skilled communications technicians.

Drone 118 may be equipped with a drone communications component 218 that is constructed or otherwise configured to serve as a communication end point of a communication channel formed with other components of CMM system 200. Such a communication channel may be used to convey information between optical scanner 115 through scanner communications component 226 and drone 118 through drone communications component 218, such as to terminate airborne CMM operations when airborne CMM 110 determines the object being scanned does not match the uploaded flight path data 276 for the object that was expected. Another communication channel may be constructed between drone communications component 218 and drone communications component 262 on CMM system server 260 for, among other things, communicating inspection flight path data 276. Similarly, optical scanner 115 may include a scanner communications component 226 that is constructed or otherwise configured to serve as a communication end point of a communication channel formed with other components of CMM system 200. Such communication channel may be formed with exemplary scanner communications component 261 on CMM system server 260 for, among other things, conveying point cloud data that may be stored in point cloud memory 228. Communications between base tracker 120 and mobile tracker 130 may be achieved through a base tracker communications component 246 and a mobile tracker communications component 237, respectively, and each of base tracker 120 and mobile tracker 130 may communicate with a tracker communications component 268 at CMM information system 150 for, among other things, conveying tracker path data 278 and reference data. Scanner communications component 226 on optical scanner 115 may communicate with base tracker communications component 246 and mobile tracker communications component 237 by which optical scanner 115 may receive reference position and other information by telecommunications. The present inventive concept may be practiced using a wide variety of signaling and telecommunication protocols that can be used therewith without departing from the spirit and intended scope thereof.

As illustrated in FIG. 2, exemplary optical scanner 110, base tracker 120 and mobile tracker 130 operate using optical scanning principles, although not necessarily the same scanning principles. Optical scanner 115 may include sensor array 222 and laser array 223, mobile tracker 130 may include sensor array 232 and laser array 233 and base tracker 120 may include sensor array 242 and laser array 243. At each subsystem, i.e., optical scanner 110, base tracker 120 and mobile tracker 130, the corresponding laser arrays 223, 233 and 243 irradiate their assigned targets, e.g., the object's surface and/or markers 117 and/or corresponding trackers 120 and 130, and the reflected light from each of those targets may be received at corresponding sensor arrays 222, 232 and 242.

Optical scanner 115 may be mechanically attached to drone 118 by hardware suitable for airborne metrology. In certain cases, optical scanner 115 may be isolated from drone 118, such as by elastic vibration absorbers, to minimize the impact of drone vibrations on accurate scanning. However, it is to be understood that the present inventive concept is not so limited; mechanisms onboard airborne scanner 110, e.g., platform stabilization component 214 on drone 118, may provide sufficient stability for component scanning. In certain embodiments, for example, platform stabilization component 214 may be constructed or otherwise configured to maintain a prescribed flight path 12A to within 300-550 mm.

As indicated above, optical scanner 115 may be mechanically coupled to drone 118 through optical scanner mount 215. Embodiments of the present inventive concept include those that equip airborne CMM 110 with a triaxial motorized gimbal mount by which optical scanner 115 may be rotated through roll, yaw and pitch angles relative to drone 118 and, by extension, to inspection flight path 12_{A} and to the surface being measured. Positional control over optical scanner mount 215 may be provided by flight controller 211 as part of the component-specific flight path data in flight path memory 213 created through, for example, site path editor 266.

As previously discussed, optical scanner 115 may irradiate a prescribed area on the surface of the object being scanned, e.g., a scanning region 111 depicted in FIG. 1, and light reflected from that area on the surface of the object may be collected, stored, transmitted, processed, and analyzed to support 3D rendering and measurement of the scanned object to within a target degree of accuracy. Reference processor 224 in optical scanner 115 may assign spatial coordinates (x_{L}, y_{L}, z_{L}) in the local reference frame to the laser return data and store coordinates (x_{L}, y_{L}, z_{L}) in point cloud memory 228. Reference processor 224 may be constructed or otherwise configured to translate the local reference frame into the global reference frame with knowledge of R₁ and R₂ and/or of R₁, R₃ and R_{T} as well as the orientation of optical scanner 115 when a specific data point was acquired. The present inventive concept can be practiced using various triangulation techniques; simple trigonometric calculations and/or sophisticated numerical techniques may be realized in exemplary reference processor 224. Range data indicative of R₂, R₃ and R_{T} may be provided to optical scanner 115 for computational translation through communication channels formed between scanner communications component 226, mobile tracker communications component 237 on mobile tracker 130 and base tracker communications component 246 on base tracker 130. Such communication channels may be realized optically through appropriate optical transmitters, e.g., lasers, and optical receivers, e.g., laser detectors, deployed at each of scanner communications component 226 on optical scanner 115, mobile tracker communications component 237 on mobile tracker 130 and tracker communications component 246 on base tracker 120. Accordingly, each of scanner communications component 226, mobile tracker communications component 237 and base tracker communications component 246 may be constructed or otherwise configured with optical communications hardware and optional software sufficient to form optical communication channels between one another as well as radio communications equipment hardware and optional software sufficient to form radio communication channels over telecommunications network 202 with scanner communications component 261 and tracker communications component 268 on CMM server 260. It is to be understood however that such configurations are exemplary; range data indicative of R₂, R₃ and R_{T} may be conveyed to optical scanner 115 through radio communication channels, for example. That is, R₂, R₃ and R_{T} may be optically measured at base tracker 120 and mobile tracker 130, as described above, and data indicative of such may be transmitted to optical scanner 115 through radio channels formed between each of scanner communications component 226, mobile tracker communications component 237 and base tracker communications component 246 as needed, routinely or continually.

Reference processor 224 on optical scanner 115 may be constructed or otherwise configured to translate data points (x_{L}, y_{L}, z_{L}) into data points (x_{G}, y_{G}, z_{G}) of a translated point cloud, as described above, for example, which may be conveyed over telecommunication network 202 through a communication channel between scanner communications component 226 in optical scanner 115 and scanner communications component 261 on CMM system server 260. There, the received data may be numerically integrated over the point cloud data structure, such as by a rendering processor 264, to generate computer-readable data that defines the surface of the object being inspected, the surface of the corresponding computer model 275 or both. Such surface data may be provided to inspection processor 265 at which discrepancies between measured (translated point cloud) and standard (computer model) surfaces are noted and those outside specified tolerances are identified and optionally reported.

In an example component inspection, base tracker 120 may be deployed at inspection site 5 at a fixed anchor position that can be stored in exemplary reference position memory 244. An operator can identify the component to be inspected from a database query on database 255 through database engine 267. The database query may result in retrieval of a database entry 270 from which drone 118 may receive component-specific flight path data 276, which it may store in flight path memory circuitry 213, and from which mobile tracker 130 may receive flightpath-specific tracker path data 278, which it may store in tracker path memory 234. The stored flight path data 276 may be accessible to flight controller 211 that is constructed or otherwise configured to provide appropriate signals to drone motors, representatively illustrated at drone motor 207, and drive the appropriate drone propellors, representatively illustrated at drone propellor 209, to traverse the corresponding component-specific flight path. Flight controller 211 may receive flight-relative information from platform stabilization component 214, which may be implemented through geo-positioning satellite (GPS) data, gyroscopic data and other mechanisms, by which drone 118 tracks the component-specific flight path 274 within a specified tolerance. Similarly, stored tracker path data 278 may be accessible to tracker path controller 231 that is constructed or otherwise configured to operate mobile drive 238 for controlling locomotors, representatively illustrated at locomotors 239, and traverse the corresponding flightpath-specific tracker path thereby.

As the component inspection proceeds, mobile tracker 130 may follow its mobile tracker path as defined by tracker path data 278 stored in tracker path memory 234. Alternatively or additionally, mobile tracker path 12_{T} may be specified to allow for path definitions or modifications, such as those that may be necessitated by a requirement to maintain a certain distance from the object under scrutiny. As discussed, mobile tracker path 12T may also be specified to maintain optical LOS between optical scanner 115 and base tracker 120 through positioning of mobile tracker 130.

Point cloud data (x_{L}, y_{L}, z_{L}) may be continually generated by optical scanner 115 and translated into coordinates (x_{G}, y_{G}, z_{G}) of the global reference frame anchored by base tracker 120 and maintained through, where necessary, mobile tracker 130. The translated point cloud may be rendered by exemplary rendering processor 264 on CMM system server 263 and inspected by exemplary inspection processor 265 as discussed above.

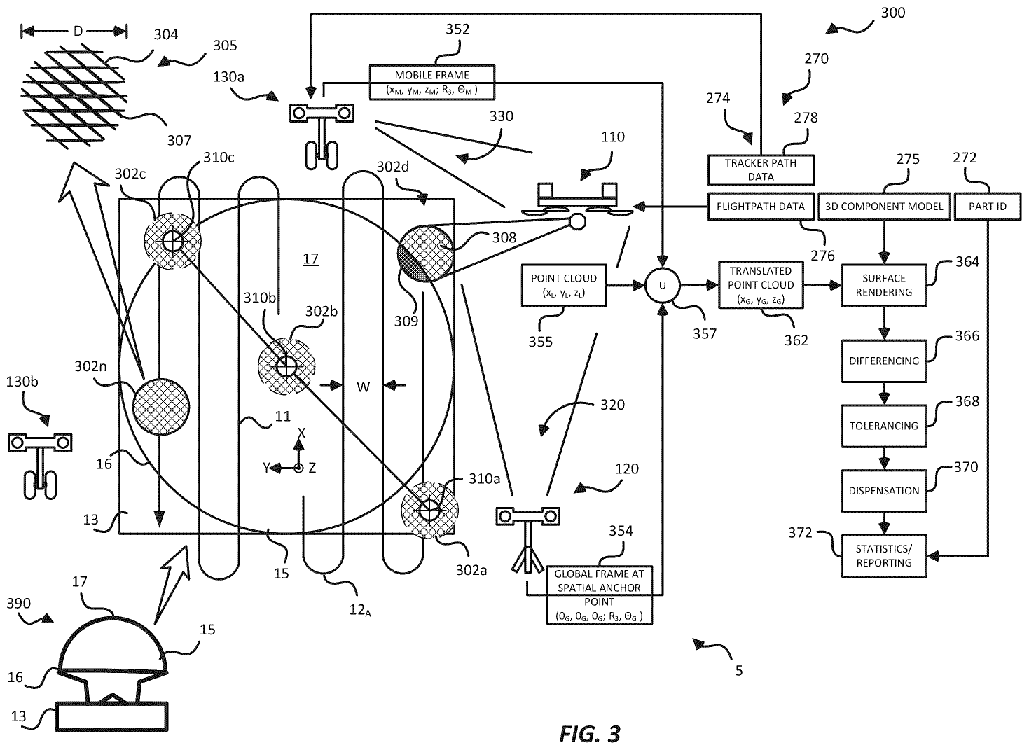

FIG. 3 is a schematic illustration of an exemplary component inspection process, referred to herein simply as inspection process 300, by which the present inventive concept can be embodied. In the illustrated example, object 390 serves as an arbitrary component under inspection that includes a dome feature 17 mounted on a base 13 whose periphery is defined by a dome lip 16. From overhead downward (into the page is the negative (−) Z direction, or downward, in global coordinates), airborne scanner 110 obtains a point cloud from a surface 15 of object 390, which may be referenced from base tracker 120 through, where applicable, mobile tracker 130. It is to be understood that features depicted in FIG. 3 are not drawn to scale or in usual relative proportion therebetween.

For purposes of explanation, it is to be assumed that an airborne CMM operator has queried a database, e.g., database 255, for a part designator or number 272 in preparation for inspection of a part having that part number. As previously discussed, such a query may return database entry 270 including, among other things, inspection site path data 274 in which flightpath data 276 and tracker path data 278 are stored in association with a 3D component model 272. Flight path data 276 may be uploaded to airborne scanner 110 and tracker path data 278 may be uploaded to mobile tracker 130a, for example. It is to be assumed further that appropriate personnel have positioned base tracker 120 for a broad view of the expected inspection flight path 12A for object 290. Mobile tracker 130a may also be positioned according to the expected flight path with additional attention paid to the fixed position of base tracker 120. A mobile tracker 130b may be deployed in regions where mobile tracker 130a is no longer capable of maintaining concurrent optical LOS with both airborne CMM 110 and base tracker 120. Various handoff techniques may be deployed for establishing which mobile tracker 130a, 130b is relaying the global origin (0_{G}, 0_{G}, 0_{G}) from base tracker 120. For purposes of explanation, the description of FIG. 3 that follows will simply refer to a mobile tracker 130, with functionality being identical once the handoff has occurred. With all components in place and initiated, airborne scanner 110 may begin the inspection.

As described above, airborne scanner 110 may acquire laser return data by compelling a scanning region, illustrated at scanning region 111 in FIG. 1, over surface 15 of object 390. Such scanning regions are illustrated in FIG. 3 at exemplary scanning regions 302a-302n, representatively referred to herein as scanning region(s) 302, and characteristics of the returned laser light from scanning region 302 may vary as airborne scanner 110 traverses inspection flight path 12_{A}. For example, airborne scanner 110 or, more specifically, optical scanner 115 may be calibrated to generate a spot 305 of size D, which is depicted as being generally circular but need not be, from a known calibration range to a calibration surface. In the illustrated example, a calibration pattern 307 of laser lines 304 interior to spot 305 may be formed when optical scanner 115 is both at the calibration range from the calibration surface and in a calibration orientation (e.g., roll, yaw, pitch) relative to that calibration surface. Spot size D and calibration pattern 307 may be specific to an optical scanner 115 and set at the manufacturer. Deviations from calibration pattern 307, as representatively depicted at exemplary scanning region 302d, are detected as scanning region 302 moves over surface 15. In the example of FIG. 3, region 309 may be higher than region 308 (in the +Z direction) and may possess detectable perturbations of pattern 307 that are distinct from those detected from region 308. The perturbations may be detected in the laser returns and represented in point cloud 355 as corresponding points (x_{L}, y_{L}, z_{L}). Other practices for generating surface indicative data may be used, including simple distance ranging, and skilled artisans will recognize how to practice the inventive concept described herein accordingly in such cases.

Inspection flight path 12A may be designed to move scanning region 302 over the entire surface 15 of a specific object 390 in swaths 11 that are equal in width to the spot size of scanning region 302. To collect enough data for component inspection against design specifications, multiple passes of scanning region 302 over the same region of surface 15 may be required. To that end, inspection flight path 12_{A} may be designed under data collection constraints of optical scanner 115 into swaths 11 separated at a distance W that is a fraction, e.g., 0.75±a tolerance measure, of the spot size at scanning region 302. When so implemented, swaths 11 may overlap and point cloud 355 may be populated more densely from the additional laser returns.

In certain embodiments, flight path data 276 may include instructions for flight over and data acquisition from one or more registration locations, representatively illustrated at registration locations 310a-310c and referred to herein as registration location(s) 310. As depicted, registration locations 310 may be scanned by way of scanning locations 302 and the corresponding laser returns may be used to establish reference locations for local reference frame in which point cloud 355 is defined. The registration operation may be used to integrate and stitch scans as point cloud 355 is being constructed in memory.

As airborne scanner 110 traverses flight path 12A, base tracker 120 may search for markers thereon through a scan volume 320 to generate range R₂ and orientation θ_{B} measurements of airborne scanner 110 from base tracker position (0_{G}, 0_{G}, 0_{G}). Mobile tracker 130 may search for markers on airborne scanner 110 through a scan volume 330 to generate range R₃ and orientation θ_{M} measurements of airborne scanner 110 from mobile tracker position (x_{M}, y_{M}, z_{M}) while concurrently maintaining optical LOS with base tracker 120. Base tracker data 354 and mobile tracker data 352 may be provided to a transform component 357 by which dimensionless point cloud 355 is translated into the global reference frame anchored at (0_{G}, 0_{G}, 0_{G}) and assigned thereby physical dimensions of translated point cloud 362 descriptive of surface 15, which may be rendered in memory by a surface rendering process 364. Surface rendering process 364 may be provided component specific model data 275 that may guide the reconstruction of surface 15 from translated point cloud data 362. The fit of translated point cloud data 362 to component model 275 may be identified by a differencing process 366 and compared to design specifications by a tolerancing process 368. The results of these inspection operations may be provided to dispensation process 370 that determines whether object 390 is to be used as is, repaired, replaced, rejected, etc. The selected dispensation may be added to statistics collected for the part identified by part designator 272 and reported to relevant entities by statistics/reporting process 372.

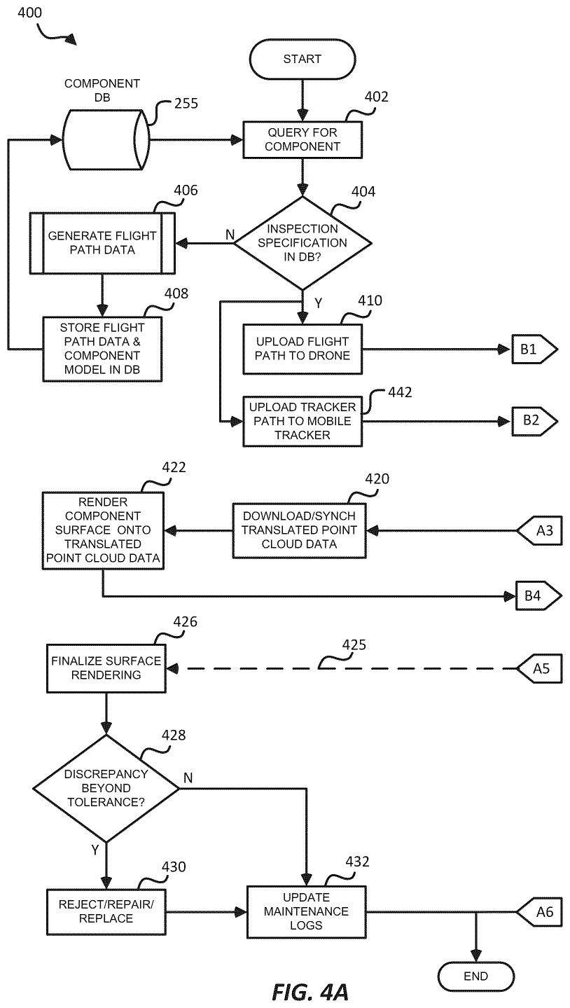

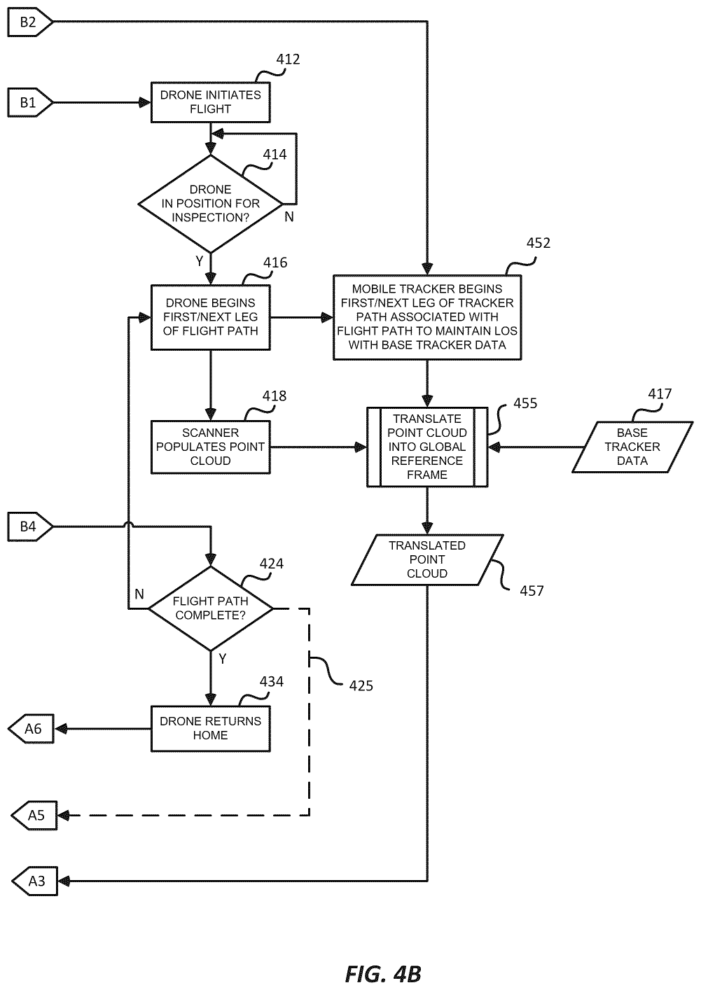

FIGS. 4A and 4B, collectively referred to herein as FIG. 4 is a flow diagram distributed over two (2) drawing pages of an exemplary airborne CMM process 400 by which the present inventive concept can be embodied. The flow diagram of FIG. 4 includes inter-page connectors labeled B1, B2, A3, B4, A5 and A6 connecting process flow paths over the two (2) drawing pages. These inter-page connectors are considered self-explanatory and recognized without further comment by skilled technicians. Accordingly, CMM process 400 will be described with reference to the flow diagram of FIG. 4 without explicitly calling out the applicable inter-page connectors.

Airborne CMM process 400 may be performed through mechanical, electrical, computational and data storage resources described above, but the present inventive concept can be practiced on different platforms without departing from the spirit and intended scope thereof. At operation 402, component database 255 may be queried for a component to be inspected. In operation 404, it may be determined whether an inspection specification exists in component database 255, which, in this case, is intended to refer to a data association of, among other things, component information, inspection site path information including both flight path and tracker path information, and a 3D component model against which to inspect. If such an inspection specification does not exist, as determined in operation 404, airborne CMM process 400 may transition to operation 406 at which a user may generate inspection site paths for the component to be inspected, such as through site path editor 266. The flight path and tracker path, once completed, may be stored with the associated component model with other component information in component database 255, as illustrated at operation 408. If an inspection specification does indeed exist, as determined in operation 404, airborne CMM process 400 may transition to operation 410 by which inspection flight path data may be uploaded to the drone and to operation 442 by which tracker path data may be uploaded to the mobile tracker.

In operation 412 of exemplary airborne CMM process 400, the drone may initiate flight, including flight that is outside the inspection flight path. This may include flight to the component from, for example, a launch station at which the airborne scanner becomes airborne. Accordingly, airborne CMM process 400 may transition to operation 414 and remain there until it has been determined thereby that the drone is in position to begin its inspection runs or legs. When the drone has reached the component inspection position, airborne CMM process 400 may transition to operation 416 by which the drone may begin the first leg of the inspection flight path uploaded for the component being inspected and, concurrently to operation 452 by which the mobile tracker traverses its tracker path to maintain LOS with both the base tracker and with the optical scanner. As the drone traverses the different legs of the inspection flight path, airborne CMM process 400 may transition to operation 418 by which the attached optical scanner begins generating data, e.g., populating a point cloud with coordinate-tagged laser return data referred to a local reference frame. Operation 455 may be a computational subprocess by which the point cloud is translated into the global reference frame by triangulation, among other computations or transforms, between the fixed anchor point at the base tracker in conjunction with range determinations at each of the base tracker, the mobile tracker and the optical scanner. The resulting data may comprise translated point cloud data 457, which may be downloaded, synched, or otherwise conveyed in operation 420 to remote data processing resources, such as exemplary CMM information system 150. In operation 422, a surface defined by the associated 3D component model may be rendered on the translated point cloud as the airborne scanner traverses the inspection flight path, leg by leg. In operation 424, it may be determined whether the inspection flight path has been completed, e.g., no legs remaining in the flight path. If not, airborne CMM process 400 may transition back to operation 416 at which the drone may begin the next leg of the inspection flight path. If the inspection flight path has been completed, as determined in operation 424, airborne CMM process 400 may transition to operation 434 by which the drone returns home, e.g., the launching station previously described although the present inventive concept is not so limited. Additionally, a positive determination at operation 424 that the inspection flight path has been completed, airborne CMM process 400 may convey a message or signal, representatively illustrated at message 425, to the ongoing or live component surface rendering operations that the flight path has been terminated and data collection has consequently ceased. In response to message 425, airborne CMM process 400 may finalize the surface rendering in operation 426 to the extent that discrepancies between the component specifications on the associated 3D component model, for example, and the surface defined on the point cloud data. If such a discrepancy is found to be beyond a specified tolerance, as determined in operation 428, the component may be rejected, repaired where possible or replaced where possible, in operation 430. The action performed in operation 430 may be recorded in applicable maintenance logs in operation 432, as may be a record of the inspection for which no discrepancy against the standard is noted.

Certain embodiments of the present general inventive concept provide for the functional components to be manufactured, transported, marketed and/or sold as processor instructions encoded on computer-readable media. The present general inventive concept, when so embodied, can be practiced regardless of the processing platform on which the processor instructions are executed and regardless of the manner by which the processor instructions are encoded on the computer-readable medium.

It is to be understood that the computer-readable medium described above may be any non-transitory medium on which the instructions may be encoded and then subsequently retrieved, decoded and executed by a processor, including electrical, magnetic and optical storage devices. Examples of non-transitory computer-readable recording media include, but not limited to, read-only memory (ROM), random-access memory (RAM), and other electrical storage; CD-ROM, DVD, and other optical storage; and magnetic tape, floppy disks, hard disks and other magnetic storage. The processor instructions may be derived from algorithmic constructions in various programming languages that realize the present general inventive concept as exemplified by the embodiments described above.

### INDUSTRIAL APPLICABILITY

Regular component inspection ensures proper equipment operation and operator safety and should therefore be incorporated into the appropriate maintenance procedures. The regularity of component inspection can be frustrated when the surface to be inspected is difficult to reach or is of such physical extent to require extensive site preparation. The present inventive concept seeks to improve efficiency of airborne coordinate measuring machines and thereby make inspections more convenient and less cumbersome to promote regular component inspection.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. An airborne coordinate measuring machine (CMM) comprising:
a noncontact 3D scanner constructed to obtain measurement data of an object under scrutiny; and
a drone aircraft mechanically coupled to the 3D scanner and constructed to traverse a flight path that is specific to the object under scrutiny.

2. The airborne CMM of claim 1, wherein the drone aircraft comprises:
propellor motors constructed to drive respective propellors in flight according to propellor drive signals provided thereto;
a flight controller communicatively coupled to the propellor motors and constructed to generate the propellor drive signals according to flight path data; and
flight path memory circuitry communicatively coupled to the flight controller and constructed to store the flight path data that, when executed by the flight controller, compels the drone aircraft to traverse the flight path that is specific to the object under scrutiny.

3. The airborne CMM of claim 2, wherein the drone aircraft further comprises a drone communications component constructed to accept the flight path data from a data source.

4. The airborne CMM of claim 1, wherein the 3D scanner comprises:
a laser array constructed to irradiate a surface region on the object under scrutiny;
a detector constructed to accept laser light reflected from the irradiated surface region; and
a reference processor constructed to associate the measurement data determined from the reflected laser light with coordinates of a local reference frame.

5. The airborne CMM of claim 4, wherein the 3D scanner further comprises a scanner communications component constructed to convey the coordinates of the local reference frame as a point cloud to a data processor.

6. The airborne CMM of claim 5, wherein the 3D scanner is a 3D optical scanner.

7. An airborne inspection metrology system constructed to inspect an object, the airborne inspection metrology system comprising:
airborne coordinate measuring machine (CMM) comprising:
a noncontact 3D scanner constructed to obtain measurement data of an object under scrutiny; and
a drone aircraft mechanically coupled to the 3D scanner and constructed to traverse a flight path that is specific to the object under scrutiny; and
an information system communicatively coupled to the 3D scanner and the drone aircraft and constructed to accept the measurement data from the 3D scanner and to convey flight path data to the drone aircraft that defines the flight path.

8. The airborne inspection metrology system of claim 7, wherein the information system comprises a database constructed to store the flight path data in association with an indicator of the object under scrutiny.

9. The airborne inspection metrology system of claim 8, wherein the information system further comprises a site path editor by which the flight path data are generated.

10. The airborne inspection metrology system of claim 8, wherein the database is further constructed to store a component model in association with the indicator of the object under scrutiny, the component model defining specifications on the object under scrutiny.

11. The airborne inspection metrology system of claim 10, wherein the information system includes an inspection processor constructed to determine whether the measurement data are within the specifications defined on the component model.

12. The airborne inspection metrology system of claim 11, wherein the airborne CMM comprises:
a laser array constructed to irradiate a surface region on the object under scrutiny;
a detector constructed to accept laser light reflected from the irradiated surface region; and
a reference processor constructed to associate the measurement data determined from the reflected laser light with coordinates of a local reference frame.

13. The airborne inspection metrology system of claim 12 further comprising:
a mobile tracker constructed to traverse a tracker path that corresponds to the flight path;
a base tracker constructed to maintain a fixed position during traversal of the flight path by the airborne CMM; and
a tracker communications component in the airborne CMM constructed to accept distance data from the mobile tracker and the base tracker, the tracker communications component being communicatively coupled to the reference processor by which the coordinates of the local reference frame are translated into coordinates of a global reference frame anchored at the fixed position.

14. The airborne inspection metrology system of claim 13, wherein the inspection processor determines whether the measurement data as assigned with the translated coordinates are within the specifications defined on the component model.

15. A method of component inspection by airborne inspection metrology, the method comprising:
irradiating a surface region on the component with an airborne laser;
accepting laser returns reflected from the irradiated surface region on the component at an airborne detector;
generating measurement data from the laser returns that are assigned coordinates of a local reference frame;
translating the coordinates of the local reference frame into coordinates of a global reference frame from which physical distance is determined; and
determining whether the measurement data translated into the global reference frame are within specifications defined on a component model of the component.

16. The method of component inspection of claim 15, further comprising:
accepting flight path data defining a flight path that is specific to the component; and
irradiating the surface region while traversing the flight path.

17. The method of component inspection of claim 16, further comprising retrieving the flight path data through a database query based on an indicator of the component.

18. The method of component inspection of claim 15, further comprising accepting distance data from at least one tracker in optical communication with the airborne detector; and
translating the coordinates of the local reference frame into the coordinates of the global reference frame using the accepted distance data.

19. The method of component inspection of claim 18, further comprising accepting the distance data from a mobile tracker traversing a tracker path that corresponds to the flight path, and from a base tracker that remains stationary relative to the component.

20. The method of component inspection of claim 19, further comprising translating the coordinates of the local reference frame into the coordinates of the global reference frame using both the distance data from the mobile tracker and the distance data from the base tracker.
